(19) United States
(12) Patent Application Publication
(10) Pub. No.: US 2013/0251428 A1
(43) Pub. Date: Sep. 26, 2013

(54) Ceramic Heater and Fixing Device

(71) Applicant: TOSHIBA LIGHTING & TECHNOLOGY CORPORATION, Yokosuka-shi (JP)

(72) Inventors: Takanobu Ueno, Imabari-shi (JP); Akio Watanabe, Imabari-shi (JP)

(73) Assignee: TOSHIBA LIGHTING & TECHNOLOGY CORPORATION, Yokosuka-shi (JP)

(21) Appl. No.: 13/832,276

(22) Filed: Mar. 15, 2013

(30) Foreign Application Priority Data
Mar. 23, 2012 (JP) 2012-066779

(51) Int. Cl. H05B 3/12; G03G 15/20; H05B 3/18

(52) U.S. Cl. CPC H05B 3/12; H05B 3/18; G03G 15/2053
USPC 399/333; 219/544; 219/553

(57) ABSTRACT

A ceramic heater according to one embodiment includes a substrate (1) composed of a ceramic, a conductive pattern (patterns (21 to 26)) formed on the substrate (1), a heating element (heating elements (41 to 45)) formed on the substrate (1) so as to be electrically connected to the patterns (21 to 26), and an overcoat layer (5) formed so as to cover at least the heating elements (41 to 45). The heating elements (41 to 45) contain graphite and an alloy composed of silver and palladium, and the percentage of the amount of graphite with respect to the total amount of the alloy and the graphite is from 16 to 47%.

### CROSS-REFERENCE TO RELATED APPLICATIONS

This application is based upon and claims the benefit of priority from the prior Japanese Patent Application No. 2012-066779, filed on Mar. 23, 2012; the entire contents of which are incorporated herein by reference.

### FIELD

Embodiments described herein relate generally to a ceramic heater and a fixing device to be used for fixing a toner or the like in a copier.

### BACKGROUND

As a heater for fixing a toner to be used in an image forming apparatus, a ceramic heater is used. The ceramic heater is a plate-shaped heater in which a conductive pattern and a heating element are provided on an elongated substrate made of a ceramic, and these members are covered with an overcoat layer. In this ceramic heater, when a paper which has a width shorter than the length in the longitudinal direction of the ceramic heater is continuously fed, heat is less likely to be conducted away from a portion where the paper is not fed through (a non-paper feeding portion) than a portion where the paper is fed through (a paper feeding portion). Therefore, it is known that the ceramic heater has a problem that the temperature of the non-paper feeding portion excessively increases.

In light of this problem, a heating element composed of a carbon material, so-called graphite, is attracting attention. It is because the heating element composed of graphite has a negative temperature coefficient resistance (hereinafter referred to as “TCR”). When an element has a negative TCR, the element is said to have a negative temperature coefficient (NTC) property and has a property in which the resistance decreases as the temperature increases. Therefore, if graphite is used in the heating element, it is possible to prevent the temperature of the non-paper feeding portion from excessively increasing even when a paper is not fed through the non-paper feeding portion.

However, graphite has a disadvantage that the sheet resistance thereof is high. If the sheet resistance is high, the total resistance is increased depending on the heating element pattern, and therefore, graphite cannot be used as a heating element or pattern designing may be restricted.

### DESCRIPTION OF THE DRAWINGS

FIG. 1 illustrates a diagram of a ceramic heater according to a first embodiment.

FIG. 2 illustrates a cross-sectional diagram of the ceramic heater according to the first embodiment taken along the line A-A′ in FIG. 1 seen from the arrows.

FIG. 3 illustrates a graph showing a relationship between a TCR and the percentage of the amount of graphite with respect to the total amount of Ag, Pd and graphite, or the total amount of Ag and graphite in a heating element.

FIG. 4 illustrates a graph showing a relationship between a sheet resistance and the percentage of the amount of graphite with respect to the total amount of Ag, Pd and graphite, or the total amount of Ag and graphite in a heating element.

FIG. 5 illustrates a graph showing a relationship between a TCR and the percentage of the amount of Ag with respect to the total amount of Ag and Pd in a heating element.

FIG. 6 illustrates a table showing a preferred material of a conductive pattern.

FIG. 7 illustrates a diagram of a fixing device according to a second embodiment.

### DETAILED DESCRIPTION

A ceramic heater according to an embodiment includes a substrate composed of a ceramic, a conductive pattern formed on the substrate, a heating element formed on the substrate so as to be electrically connected to the conductive pattern, and an overcoat layer formed so as to cover at least the heating element. The heating element contains graphite and an alloy composed of silver and palladium, and the percentage of the amount of graphite with respect to the total amount of the alloy and the graphite is from 16 to 47%.

According to another embodiment, a ceramic heater which includes a substrate composed of a ceramic, a conductive pattern formed on the substrate, a heating element formed on the substrate so as to be electrically connected to the conductive pattern, and an overcoat layer formed so as to cover at least the heating element, and in which the heating element contains graphite and an alloy composed of silver and palladium and having a silver content of 95% or more, or a metal composed of silver, and the percentage of the amount of graphite with respect to the total amount of the alloy or the metal and the graphite is from 28 to 47% is provided.

According to another embodiment, a ceramic heater which includes a substrate composed of a ceramic and a heating element formed on the substrate, and in which the heating element contains graphite and an alloy composed of silver and palladium, or a metal composed of silver, and the percentage of the amount of graphite with respect to the total amount of the alloy or the metal and the graphite is from 16 to 47% is provided.

According to another embodiment, a fixing device including any of the above-described ceramic heaters, a fixing film in which the ceramic heater is disposed, and a pressure roller which is elastically in contact with the ceramic heater through the fixing film is provided.

Hereinafter, embodiments for implementing the invention will be described.

### First Embodiment

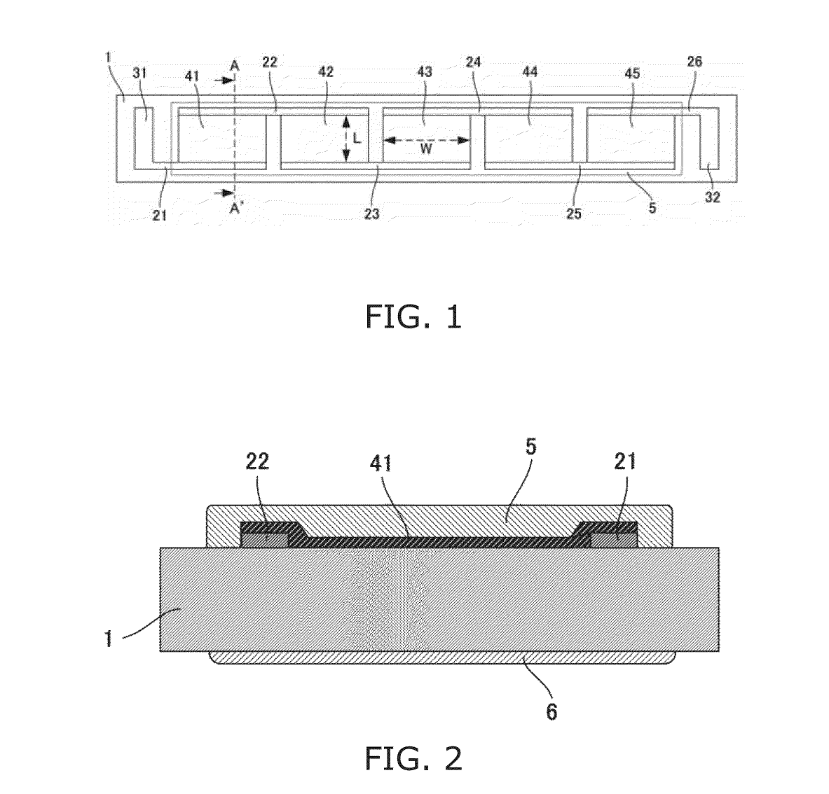

A ceramic heater according to a first embodiment will be described with reference to the accompanying drawings. FIG. 1 illustrates a diagram of the ceramic heater according to the first embodiment, and FIG. 2 illustrates a cross-sectional diagram of the ceramic heater according to the first embodiment taken along the line A-A′ in FIG. 1 seen from the arrows.

The ceramic heater is a heater to be used for fixing a toner, and is provided with a substrate 1 as a main part. The substrate 1 is an elongated substrate having, for example, a thickness of 1 mm, a width of 10 mm, and a length of 280 mm. The substrate 1 is composed of a ceramic material having excellent insulating property and thermal conductivity such as aluminum oxide (Al₂O₃) or aluminum nitride (AlN).

On one surface of the substrate 1, a conductive pattern is formed. In this embodiment, the conductive pattern includes a plurality of patterns 21 to 26. The patterns 21 to 26 are patterns composed of, for example, silver (Ag) or an alloy of silver and palladium (Ag/Pd), and are formed into a long and narrow shape along the longitudinal direction of the substrate 1. Among these, the patterns 21, 23, and 25 are formed substantially in a straight line, and also the patterns 22, 24, and 26 are formed substantially in a straight line. Further, the patterns 21, 23, and 25 and the patterns 22, 24, and 26 are formed substantially in parallel to each other, respectively, while keeping a predetermined interval. An electrode part 31 and an electrode part 32 each serving as a part to which an electric power is supplied are integrally formed with the pattern 21 and the pattern 26, respectively, at one end thereof.

Further, on the surface of the substrate 1, a heating element is formed so as to be electrically connected to the conductive pattern. The heating element is a resistance element that contains a carbon material such as graphite (C) and an alloy composed of silver and palladium, or a metal composed of silver. The percentage (by weight) of the amount of graphite with respect to the total amount of the alloy or the metal and graphite is set to 16 to 47%. In the case of an alloy, the percentage of the amount of silver with respect to the total amount of silver and palladium is set to 25% or more, particularly 25 to 95%. Incidentally, in the heating element, a filler made of a glass or alumina, and the like can be further incorporated.

In this embodiment, the heating element includes a plurality of heating elements 41 to 45. The heating elements 41 to 45 are formed such that the heating element 41 is formed between the pattern 21 and the pattern 22, the heating element 42 is formed between the pattern 22 and the pattern 23, the heating element 43 is formed between the pattern 23 and the pattern 24, the heating element 44 is formed between the pattern 24 and the pattern 25, and the heating element 45 is formed between the pattern 25 and the pattern 26. The advantage of dividing the heating element into the plurality of heating elements 41 to 45 in the longitudinal direction of the substrate 1 in this manner is to decrease the total resistance by allowing the size of the heating element to be applicable to various sizes of paper and preventing the elongation of the heating element in the electric current flow direction. That is, in the case of a small-sized paper, the paper can be brought into contact with only, for example, the heating elements 42 to 44, and also when the length along the electric current flow direction of the heating elements 41 to 45 is represented by L and the width thereof is represented by W, it becomes easy to configure the heating element to satisfy the relationship: L<W, and therefore, the length of the heating elements 41 to 45 in the electric current flow direction can be decreased.

Further, on the surface of the substrate 1, an overcoat layer 5 is formed so as to cover at least the heating elements 41 to 45. The overcoat layer 5 is composed of, for example, a glass having a firing temperature of from 400 to 500° C. The firing temperature is a temperature at which a glass powder is melted and transformed into a film by heating, and generally corresponds to a temperature which is higher than the softening temperature by 10 to 50° C. Examples of such a glass include a bismuth salt-based glass, a bismuth zinc-based glass, a phosphate-based glass, a zinc phosphate-based glass, and a vanadium-based glass. In particular, a bismuth-based glass containing bismuth oxide (Bi₂O₃) is preferred. Further, in the glass, a filler composed of an oxide, a nitride, silica, or the like is added for adjusting the thermal coefficient of expansion with the heating element or the like.

On the other surface of the substrate 1, a sliding layer 6 is formed. The sliding layer 6 is composed of a glass having a smoother surface than the overcoat layer 5 and becomes a surface on the paper feeding side. That is, heat is generated on the side of the heating element, and a toner is fixed on the side of the sliding layer 6 while a paper is fed through the surface.

A method for producing the ceramic heater according to this embodiment will be described.

First, onto one surface of the substrate 1 composed of a ceramic, a conductive paste is applied by screen printing, followed by drying and then firing, whereby the patterns 21 to 26 and the electrodes 31 and 32 are formed. As the conductive paste, for example, a paste containing silver, an organic solvent, a binder, a zinc borosilicate glass, and the like can be used. Subsequently, onto the other surface of the substrate 1, a glass paste is applied by screen printing, followed by drying and then firing, whereby the sliding layer 6 is formed. Thereafter, a resistive paste is applied onto the substrate 1 by screen printing so as to be overlaid on the patterns 21 to 26, followed by drying and then firing, whereby the heating elements 41 to 45 are formed. As the resistive paste, a paste containing an alloy composed of silver and palladium or a metal composed of silver, graphite, an organic solvent, a binder, a zinc borosilicate glass, and the like can be used.

Subsequently, a glass paste is applied onto the substrate 1 by screen printing so as to cover the heating elements 41 to 45, followed by drying and then firing, whereby the overcoat layer 5 is formed. As the glass paste, for example, a paste containing a glass, an organic solvent, a binder containing ethyl cellulose as a viscosity increasing agent, an alumina (Al₂O₃) powder as a filler, and the like can be used. As the glass, a glass having a firing temperature of from 400 to 500° C. is preferably used. This is because the carbon-based heating elements 41 to 45 are exhausted by oxidation and combustion at around 500 to 700° C. In this embodiment, a bismuth-based glass composed of bismuth oxide (Bi₂O₃), boron oxide (B₂O₃), and an alkali metal and having a softening point of 438° C. is used. In this manner, the ceramic heater is completed.

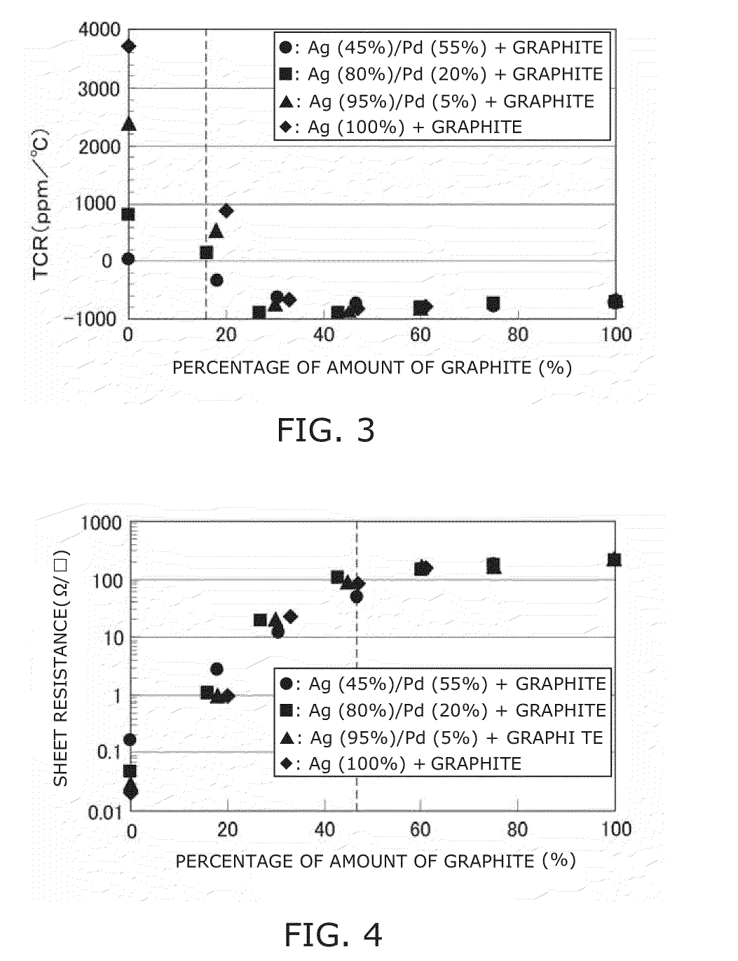

Here, an examination was made as to how the TCR changed when the composition of the materials of the heating element was changed. The results are shown in FIG. 3. The black circle () shows a TCR when the percentage of the amount of graphite with respect to the total amount of an Ag/Pd alloy (Ag:Pd=45%:55%) and the graphite was changed from 0 to 100%. Similarly, the black square (▪) shows a TCR when the percentage of the amount of graphite with respect to the total amount of an Ag/Pd alloy (Ag:Pd=80%:20%) and the graphite was changed from 0 to 100%, the black triangle (▴) shows a TCR when the percentage of the amount of graphite with respect to the total amount of an Ag/Pd alloy (Ag:Pd=95%:5%) and the graphite was changed from 0 to 100%, and the black lozenge (♦) shows a TCR when the percentage of the amount of graphite with respect to the total amount of a metal (100% Ag) and the graphite was changed from 0 to 100%. Incidentally, the TCR was expressed as a resistance changing ratio at 25° C. to 180° C.

From the results, it is found that regardless of the ratio of Ag to Pd, the TCR can be made low when the percentage of the amount of graphite is high. In particular, it is found that when the percentage of the amount of graphite is 16% or more, the TCR drastically decreases as compared with the case where the percentage of the amount of graphite is 0%, in other words, the percentage of the total amount of Ag and Pd or the amount of Ag is 100%. It is also found that when the percentage of the amount of graphite is 26% or more, the TCR decreases to a value equal to the TCR which is about −800 ppm/° C. in the case where the percentage of the amount of graphite is 100%. Therefore, in order to realize a heating element having a low TCR, it is preferred to set the percentage of the amount of graphite with respect to the total amount of an Ag/Pd alloy or Ag and the graphite to 16% or more, particularly 26% or more.

Further, an examination was made as to how the sheet resistance changed when the composition of the materials of the heating element was changed. The results are shown in FIG. 4.

From the results, it is found that regardless of the ratio of Ag to Pd, the sheet resistance can be made low when the percentage of the amount of graphite is low. In particular, it is found that when the percentage of the amount of graphite is 47% or less, the sheet resistance tends to start to drastically decrease. It is also found that when the percentage of the amount of graphite is 40% or more, the sheet resistance decreases to about 50Ω/□, which is a quarter of the sheet resistance (about 200Ω/□) in the case where the percentage of the amount of graphite is 100%. Therefore, in order to realize a heating element having a low sheet resistance, it is preferred to set the percentage of the amount of graphite with respect to the total amount of an Ag/Pd alloy or Ag and the graphite to 47% or less, particularly 40% or less.

From the above results, in order to realize a heating element having a low TCR and a low sheet resistance, it is preferred to set the percentage of the amount of graphite with respect to the total amount of an Ag/Pd alloy or Ag and the graphite is to 16 to 47% or less, particularly 26 to 40%.

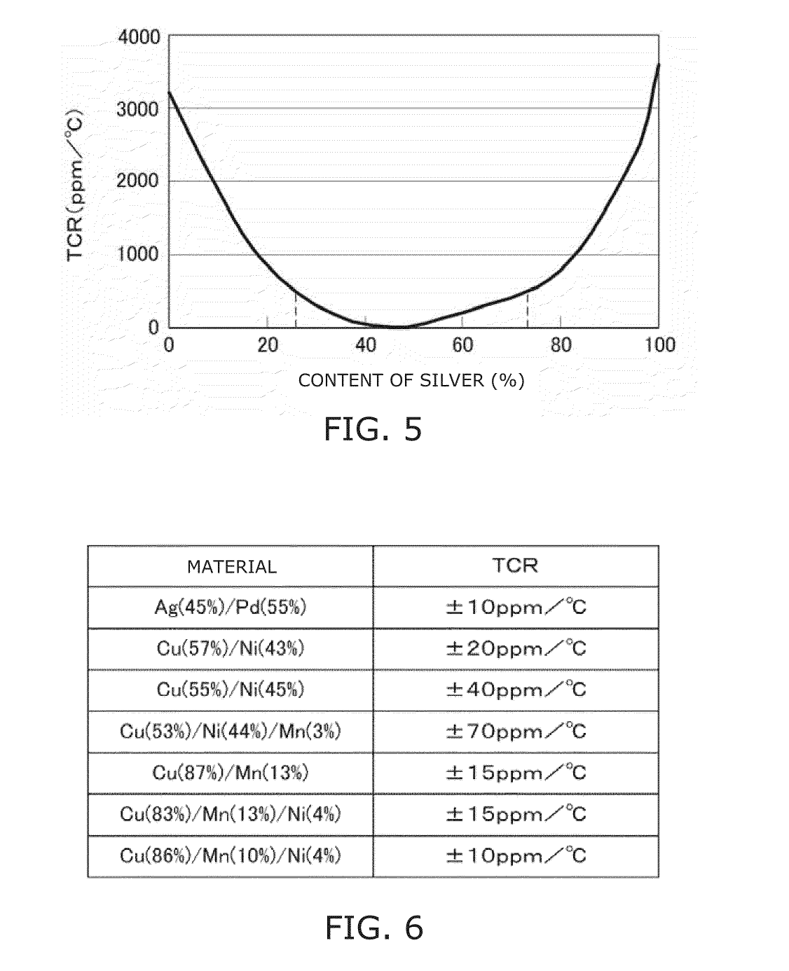

FIG. 5 illustrates a graph showing a relationship between a TCR and the content (by weight) of silver in an Ag/Pd alloy.

From the results, it is found that the TCR increases whether the content of Ag in the Ag/Pd alloy is too high or too low. Specifically, it is found that the TCR is as high as about 3200 ppm/° C. when the content of Ag is 0%, i.e., the content of Pd is 100%, and the TCR is as high as about 3600 ppm/° C. when the content of Ag is 100%, however, the TCR is 0 ppm/° C., which is the minimum value, when the content of Ag is 45%. The change in TCR by changing the percentage of the amount of graphite with respect to the total amount of the Ag/Pd alloy (Ag:Pd=45%:55%) and the graphite is as shown by the black circle () in FIG. 3. As found from FIG. 3, even if the percentage of the amount of graphite is 0%, the TCR is 0 ppm/° C., and therefore, the TCR of the heating element can be decreased to a negative value merely by mixing a small amount of graphite. In other words, a heating element obtained by mixing graphite with an Ag/Pd alloy (Ag:Pd=45%:55%) is most suitable. The case where the content of Ag is from 25 to 74%, which provides an Ag/Pd alloy having a TCR of 500 ppm/° C. or less, is preferred because the TCR of the heating element can be decreased to a negative value if the percentage of the amount of graphite is 16% or more. Incidentally, since Pd is an expensive metal, it is more preferred that the content of Ag is from 40 to 74%. As found from FIG. 4, even if the content of Ag in the Ag/Pd alloy is changed, the change in sheet resistance is relatively small, and therefore, the effect of the content of Ag on the sheet resistance of the heating element can be ignored.

Further, even in the case of an Ag/Pd alloy having an Ag content of 74% or more and 100% or less, if the TCR of a heating element is low, such a heating element may be used. As found from FIG. 5, if the content of Ag is 95% or less, the TCR can be made fairly low as compared with the case when the content of Ag is 100%. From the results shown by the black triangle (▴) in FIG. 4, it is found that if the percentage of the amount of graphite with respect to the total amount of an Ag/Pd alloy (Ag:Pd=95%:5%) and the graphite is 23% or more, the TCR of the heating element can be decreased to a negative value. Therefore, in the case of an Ag/Pd alloy having an Ag content of from 74 to 95%, if the percentage of the amount of graphite with respect to the total amount of the alloy and the graphite is from 23 to 47%, a heating element which is inexpensive and has a low TCR and a low sheet resistance can be realized. Further, from the results shown by the black lozenge (♦) in FIG. 4, it is found that if the percentage of the amount of graphite with respect to the total amount of a metal (100% Ag) and the graphite is 28% or more, the TCR of the heating element can be decreased to a negative value. Therefore, in the case of an Ag/Pd alloy having an Ag content of from 95 to 100%, if the percentage of the amount of graphite with respect to the total amount of the alloy and the graphite is from 28 to 47%, a heating element which is inexpensive and has a low TCR and a low sheet resistance can be realized.

Further, the heating element is connected to the conductive pattern, and therefore can be affected by the TCR of the conductive pattern. For example, if a silver conductive pattern and a graphite heating element are formed, the TCR of the graphite heating element is deteriorated by about 5% in some cases. Therefore, it is preferred that as the conductive pattern, a material having a low TCR, for example, having a TCR of 70 ppm/° C. or less, particularly 10 ppm/° C. or less is used. It is more preferred that the material to be used in the conductive pattern has a low sheet resistance. As such a material, as shown in FIG. 6, an Ag/Pd-based alloy, a Cu/Ni-based alloy, a Cu/Mn-based alloy, or the like can be used. In FIG. 6, the reason why the TCR value is preceded by the ± sign is that there may be an effect of a film thickness or the like, or an error in a measurement.

In the first embodiment, the TCR can be decreased by constituting the heating element by graphite and an alloy composed of silver and palladium, and setting the percentage of the amount of graphite with respect to the total amount of the alloy and the graphite to 16 to 47%, and therefore, it is possible to prevent the temperature of the non-paper feeding portion from excessively increasing. In addition, since the sheet resistance can be decreased, the restriction on designing of the heater can be reduced. For example, in the case of a pattern in which the heating element is divided into a plurality of elements as in this embodiment, by increasing the number of divided heating elements in the pattern, the heater can be flexibly applied to papers of various sizes.

At this time, the TCR can be decreased to a negative value by setting the content of silver in the alloy to 25 to 74%, or by setting the content of silver in the alloy to 74 to 95% and also setting the percentage of the amount of graphite with respect to the total amount of the alloy and the graphite to 23 to 47%, or by setting the content of silver in the alloy to 95% or more and also setting the percentage of the amount of graphite with respect to the total amount of the alloy and the graphite to 28 to 47%, and therefore, it is possible to further prevent the temperature of the non-paper feeding portion from excessively increasing.

In addition, by constituting the conductive pattern by a material having a TCR of 70 ppm7° C. or less, it is possible to prevent an increase in TCR of the heating element due to the conductive pattern.

### Second Embodiment

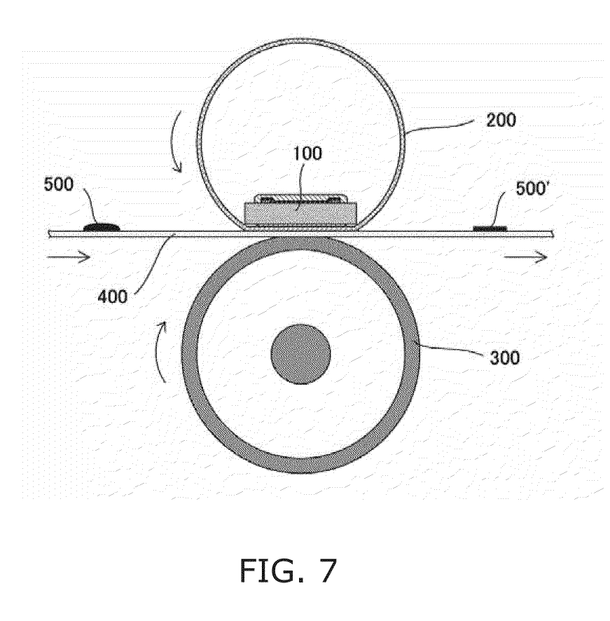

FIG. 7 illustrates a diagram of a fixing device according to a second embodiment. As for the respective parts of the second embodiment, the same parts as those of the ceramic heater of the first embodiment are assigned the same reference numerals, and the description thereof is omitted.

The fixing device is provided with a ceramic heater 100, a fixing film 200, and a pressure roller 300. In fact, the fixing device is provided in a housing, however, a part such as a housing is omitted.

The ceramic heater 100 is a heater described in the first embodiment.

The fixing film 200 is a roll-shaped film composed of a heat-resistant sheet made of a polyimide resin or the like. In this fixing film 200, the ceramic heater 100 is disposed such that a sliding layer 6 is in contact with the film.

The pressure roller 300 is a roller configured to be rotatable about a rotation axis. On a surface of the roller, a silicone rubber layer is formed as a heat-resistant elastic material. The silicone rubber layer is elastically in contact with the sliding layer 6 of the ceramic heater 100 through the fixing film 200.

An electric current is allowed to pass through the ceramic heater 100 via a connector (not shown) connected to electrodes 31 and 32, and heat is generated in a heating element. The heat is transferred to the sliding layer 6 through a substrate to heat the fixing film 200 and the pressure roller 300. When a paper 400 having a toner image 500 attached thereto is conveyed to the heated portion by the rotation of the fixing film 200 and the pressure roller 300, the toner image 500 is melted by heating, and then softened by melting. Thereafter, on the paper discharge side of the pressure roller 300, the paper 400 is separated from the ceramic heater 100, and the toner image 500′ is cooled and solidified by natural heat radiation and separated from the fixing device.

In this manner, the toner is fixed to the paper, however, even if the paper 400 having a width shorter than the length in the longitudinal direction of the ceramic heater 100 is fed therethrough, the temperature of the non-paper feeding portion can be prevented from excessively increasing by the ceramic heater 100 of this embodiment.

The invention is not limited to the above-described embodiments, and various modifications can be made.

For example, the heating element may be formed along the longitudinal direction of the substrate 1 and may be configured to be connected to a conductive pattern at both ends thereof.

The sliding layer 6 is not essential, in other words, a configuration in which a paper is fed on the side of the overcoat layer 5 may be adopted.

According to the present embodiment, a ceramic heater and a fixing device having a low TCR and a low sheet resistance can be provided.

While the present invention has been described with reference to exemplary embodiments, these embodiments are presented by way of example only, and are not intended to limit the scope of the invention. These novel embodiments can be carried out in various other forms, and various omissions, substitutions, and changes can be made therein without departing from the spirit of the invention. These embodiments and modifications thereof are included in the scope and spirit of the invention and are included in the scopes of the inventions described in the claims and their equivalent scopes.

What is claimed is:

1. A ceramic heater, comprising:
a substrate composed of a ceramic;
a conductive pattern formed on the substrate;
a heating element formed on the substrate so as to be electrically connected to the conductive pattern; and
an overcoat layer formed so as to cover at least the heating element, wherein
the heating element contains graphite and an alloy composed of silver and palladium, and the percentage of the amount of graphite with respect to the total amount of the alloy and the graphite is from 16 to 47%.

2. The heater according to claim 1, wherein the content of silver in the alloy is from 25 to 74%.

3. The heater according to claim 1, wherein the content of silver in the alloy is from 74 to 95%, and also the percentage of the amount of graphite with respect to the total amount of the alloy and the graphite is from 23 to 47%.

4. The heater according to claim 1, wherein the conductive pattern has a temperature coefficient resistance of 70 ppm/° C. or less.

5. A ceramic heater, comprising:
a substrate composed of a ceramic;
a conductive pattern formed on the substrate;
a heating element formed on the substrate so as to be electrically connected to the conductive pattern; and
an overcoat layer formed so as to cover at least the heating element, wherein
the heating element contains graphite and an alloy composed of silver and palladium and having a silver content of 95% or more, or a metal composed of silver, and the percentage of the amount of graphite with respect to the total amount of the alloy or the metal and the graphite is from 28 to 47%.

6. The heater according to claim 5, wherein the conductive pattern has a temperature coefficient resistance of 70 ppm/° C. or less.

7. A ceramic heater, comprising a substrate composed of a ceramic and a heating element formed on the substrate, wherein
the heating element contains graphite and an alloy composed of silver and palladium, or a metal composed of silver, and the percentage of the amount of graphite with respect to the total amount of the alloy or the metal and the graphite is from 16 to 47%.

8. The heater according to claim 7, wherein the conductive pattern has a temperature coefficient resistance of 70 ppm/° C. or less.

9. A fixing device, comprising:
a ceramic heater, which includes a substrate composed of a ceramic, a conductive pattern formed on the substrate, a heating element formed on the substrate so as to be electrically connected to the conductive pattern, and an overcoat layer formed so as to cover at least the heating element, and in which the heating element contains graphite and an alloy composed of silver and palladium, and the percentage of the amount of graphite with respect to the total amount of the alloy and the graphite is from 16 to 47%;
a fixing film in which the ceramic heater is disposed; and
a pressure roller which is elastically in contact with the ceramic heater through the fixing film.

10. The device according to claim 9, wherein the conductive pattern has a temperature coefficient resistance of 70 ppm/° C. or less.

11. A fixing device, comprising:
a ceramic heater, which includes a substrate composed of a ceramic, a conductive pattern formed on the substrate, a heating element formed on the substrate so as to be electrically connected to the conductive pattern, and an overcoat layer formed so as to cover at least the heating element, and in which the heating element contains graphite and an alloy composed of silver and palladium and having a silver content of 95% or more, or a metal composed of silver, and the percentage of the amount of graphite with respect to the total amount of the alloy or the metal and the graphite is from 28 to 47%;
a fixing film in which the ceramic heater is disposed; and
a pressure roller which is elastically in contact with the ceramic heater through the fixing film.

12. The device according to claim 11, wherein the conductive pattern has a temperature coefficient resistance of 70 ppm/° C. or less.

13. A fixing device, comprising:
a ceramic heater, which includes a substrate composed of a ceramic and a heating element formed on the substrate, and in which the heating element contains graphite and an alloy composed of silver and palladium, or a metal composed of silver, and the percentage of the amount of graphite with respect to the total amount of the alloy or the metal and the graphite is from 16 to 47%;
a fixing film in which the ceramic heater is disposed; and
a pressure roller which is elastically in contact with the ceramic heater through the fixing film.

14. The device according to claim 13, wherein the conductive pattern has a temperature coefficient resistance of 70 ppm/° C. or less.
